(19) United States
(12) Patent Application Publication
(10) Pub. No.: US 2023/0275926 A1
(43) Pub. Date: Aug. 31, 2023

(54) PLATFORM-CAPABILITY-POLICY PROFILES

(71) Applicant: Microsoft Technology Licensing, LLC, Redmond, WA (US)

(72) Inventors: Doreen Lynn GALLI, Henderson, NV (US); Anna SKOBODZINSKI, New York, NY (US); Brian Eric SWAN, Woodinville, WA (US); Shashwat CHANDRA, Bothell, WA (US); Lucio Cunha TINOCO, Mercer Island, WA (US)

(21) Appl. No.: 17/707,673

(22) Filed: Mar. 29, 2022

Related U.S. Application Data
(60) Provisional application No. 63/314,286, filed on Feb. 25, 2022.

(51) Int. Cl. H04L 9/40

(52) U.S. Cl. CPC H04L 63/20; H04L 63/101; H04L 63/102; H04L 63/105

(57) ABSTRACT

Platform-capability-policy profiles are pre-configured, pre-bundled sets of platform-capability policies. A user interface allows a user of a platform to select a platform capability-policy profile. The selected platform-capability-policy profile is applied to a subscription that is associated with the platform of the user. Then, platform capabilities of the subscription are managed according to the applied platform-capability-policy profile.

### CROSS-REFERENCE TO RELATED APPLICATIONS

This application claims priority to, and the benefit of, U.S. Provisional Application Serial No. 63/314,286, filed Feb. 25, 2022, and entitled “PLATFORM-CAPABILITY-POLICY PROFILES,” the entire contents of which are incorporated by reference herein in their entirety.

### BACKGROUND

Cloud services are infrastructure, platforms, or software that may be hosted by providers and made available to users through the internet. Cloud services may facilitate the flow of user data from front-end clients (e.g., users’ servers, tablets, desktops, laptops-anything on the users’ ends), through the internet, to the provider’s systems, and back. Users can typically access cloud services with nothing more than a computer, operating system, and internet connectivity or virtual private network (VPN).

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The disclosed technology is generally directed to profiles that are pre-configured, pre-bundled sets of platform-capability policies. Platform-capability policies may be set when a user subscribes to a platform such as a cloud services platform. The set of platform-capability policies may govern, for subscribers, platform-capability issues that relate to security, resilience, sovereignty, governance, dynamism, scale, and the like. For example, a policy may, by auditing or enforcement, prevent users from using certain capabilities of the platform. For instance, a user might not be allowed to access a particular platform asset for one of the above reasons such as security or resilience. As another example, if a user was making use of cloud services to create a virtual machine, and the user was trying to set up the virtual machine so that all IP addresses are able to access the virtual machine, the policy might disallow this option for security reasons. The selection and application of multiple policies can be relatively complex, and may present issues such as compatibility and various configuration issues. By bundling sets of policies together as pre-configured policies, a user may select a profile to be applied to the user’s subscription in a manner that is substantially simpler than selecting and applying separate profiles.

In some aspects, the techniques described herein relate to an apparatus, including: a device including at least one memory having processor-executable code stored therein, and at least one processor that is adapted to execute the processor-executable code, wherein the processor-executable code includes processor-executable instructions that, in response to execution, enable the device to perform actions, including: via a user interface (UI), allowing a user of a platform to select a platform-capability-policy profile; applying the selected platform-capability profile to a subscription that is associated with the platform of the user; and managing platform capabilities of the subscription according to the applied platform-capability-policy profile.

In some aspects, the techniques described herein relate to a method, including: via a UI, allowing a user of a platform to select a platform-capability-policy profile; applying the selected platform-capability profile to a subscription that is associated with the platform of the user; and via at least one processor, managing platform capabilities of the subscription according to the applied platform-capability-policy profile.

In some aspects, the techniques described herein relate to a processor-readable storage medium, having stored thereon processor-executable code that, upon execution by at least one processor, enables actions, including: via a UI, allowing a user of a platform to select a platform-capability-policy profile; applying the selected platform-capability profile to a subscription that is associated with the platform of the user; and managing platform capabilities of the subscription according to the applied platform-capability-policy profile.

Other aspects of and applications for the disclosed technology will be appreciated upon reading and understanding the attached figures and description.

### BRIEF DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

For a better understanding of the present disclosure, reference will be made to the following Detailed Description, which is to be read in association with the accompanying drawings, in which:

FIG. 1 is a block diagram illustrating one example of a suitable environment in which aspects of the technology may be employed;

FIG. 2 is a block diagram illustrating one example of a suitable computing device according to aspects of the disclosed technology;

FIG. 3 is a block diagram illustrating an example of a network-connected system;

FIG. 4 is a block diagram illustrating an example of a system for platform-capability-policy profiles; and

FIG. 5 is a flow diagram illustrating an example process for platform-capability-policy profiles, in accordance with aspects of the disclosure.

### DETAILED DESCRIPTION

The following description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on,” and includes the option of being based on additional factors, some of which may not be described herein. As another example, the term “via” is not exclusive, and is equivalent to the term “via, at least in part,” and includes the option of being via additional factors, some of which may not be described herein. The meaning of “in” includes “in” and “on.” The phrase “in one embodiment,” or “in one example,” as used herein does not necessarily refer to the same embodiment or example, although it may. Use of particular textual numeric designators does not imply the existence of lesser-valued numerical designators. For example, reciting “a widget selected from the group consisting of a third foo and a fourth bar” would not itself imply that there are at least three foo, nor that there are at least four bar, elements. References in the singular are made merely for clarity of reading and include plural references unless plural references are specifically excluded. The term “or” is an inclusive “or” operator unless specifically indicated otherwise. For example, the phrases “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof. The term “cloud” or “cloud computing” refers to shared pools of configurable computer system resources and higher-level services over a wide-area network, typically the Internet. “Edge” devices refer to devices that are not themselves part of the cloud, but are devices that serve as an entry point into enterprise or service provider core networks.

The disclosed technology is generally directed to profiles that are pre-configured, pre-bundled sets of platform-capability policies. Platform-capability policies may be set when a user subscribes to a platform such as a cloud services platform. The set of platform-capability policies may govern platform-capability issue for the subscriber that relate to security, resilience, sovereignty, governance, dynamism, scale, and the like. For example, a policy may, by auditing or enforcement, prevent users from using certain capabilities of the platform. For instance, a user might not be allowed to access a particular platform asset for one of the above reasons such as security or resilience. As another example, if a user was making use of cloud services to create a virtual machine, and the user was trying to set up the virtual machine so that all IP addresses are able to access the virtual machine, the policy might disallow this option for security. The selection and application of multiple policies can be relatively complex, and may present issues such as compatibility and various configuration issues. By bundling sets of policies together as pre-configured policies, a user may select a profile to be applied to the user’s subscription in a manner that is substantially simpler than selecting and applying separate profiles.

### Illustrative Devices/Operating Environments

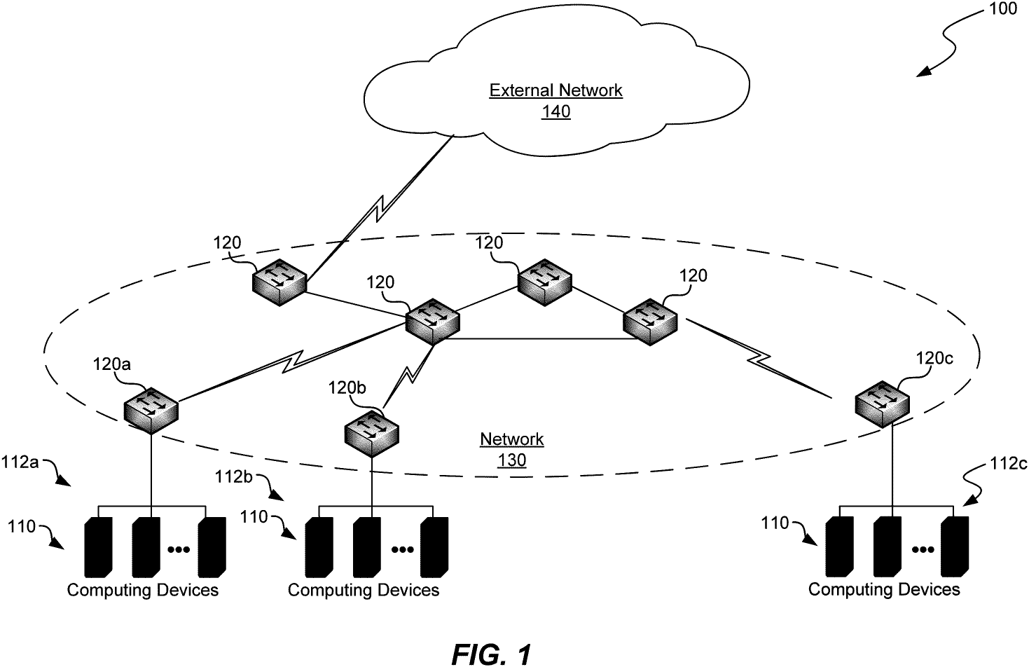

FIG. 1 is a diagram of environment 100 in which aspects of the technology may be practiced. As shown, environment 100 includes computing devices 110, as well as network nodes 120, connected via network 130. Even though particular components of environment 100 are shown in FIG. 1, in other examples, environment 100 can also include additional and/or different components. For example, in certain examples, the environment 100 can also include network storage devices, maintenance managers, and/or other suitable components (not shown). Computing devices 110 shown in FIG. 1 may be in various locations, including a local computer, on premise, in the cloud, or the like. For example, computer devices 110 may be on the client side, on the server side, or the like.

As shown in FIG. 1, network 130 can include one or more network nodes 120 that interconnect multiple computing devices 110, and connect computing devices 110 to external network 140, e.g., the Internet or an intranet. For example, network nodes 120 may include switches, routers, hubs, network controllers, or other network elements. In certain examples, computing devices 110 can be organized into racks, action zones, groups, sets, or other suitable divisions. For example, in the illustrated example, computing devices 110 are grouped into three host sets identified individually as first, second, and third host sets 112a-112c. In the illustrated example, each of host sets 112a-112c is operatively coupled to a corresponding network node 120a-120c, respectively, which are commonly referred to as “top-of-rack” or “TOR” network nodes. TOR network nodes 120a-120c can then be operatively coupled to additional network nodes 120 to form a computer network in a hierarchical, flat, mesh, or other suitable types of topology that allows communications between computing devices 110 and external network 140. In other examples, multiple host sets 112a-112c may share a single network node 120. Computing devices 110 may be virtually any type of general- or specific-purpose computing device. For example, these computing devices may be user devices such as desktop computers, laptop computers, tablet computers, display devices, cameras, printers, or smartphones. However, in a data center environment, these computing devices may be server devices such as application server computers, virtual computing host computers, or file server computers. Moreover, computing devices 110 may be individually configured to provide computing, storage, and/or other suitable computing services.

In some examples, one or more of the computing devices 110 is a device that is configured to be at least part of a process for platform-capability-policy profiles.

### Illustrative Computing Device

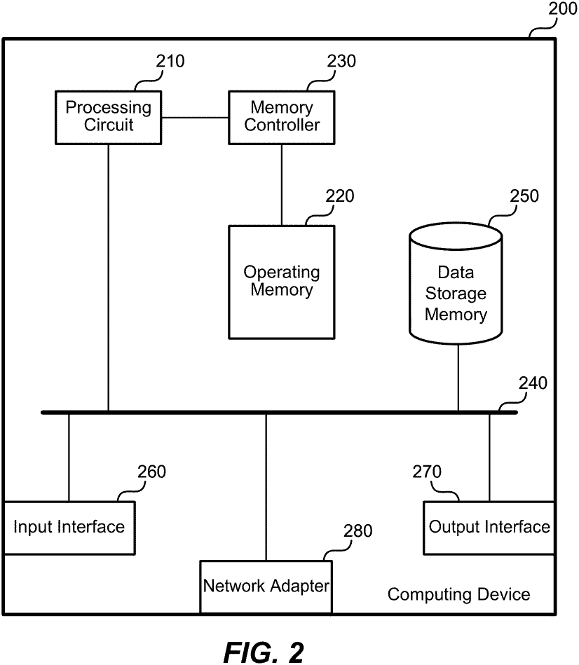

FIG. 2 is a diagram illustrating one example of computing device 200 in which aspects of the technology may be practiced. Computing device 200 may be virtually any type of general- or specific-purpose computing device. For example, computing device 200 may be a user device such as a desktop computer, a laptop computer, a tablet computer, a display device, a camera, a printer, or a smartphone. Likewise, computing device 200 may also be a server device such as an application server computer, a virtual computing host computer, or a file server computer, e.g., computing device 200 may be an example of computing device 110 or network node 120 of FIG. 1. Likewise, computing device 200 may be an example any of the devices, a device within any of the distributed systems, illustrated in or referred to in any of the following figures, as discussed in greater detail below. As illustrated in FIG. 2, computing device 200 may include processing circuit 210, operating memory 220, memory controller 230, bus 240, data storage memory 250, input interface 260, output interface 270, and network adapter 280. Each of these afore-listed components of computing device 200 includes at least one hardware element.

Computing device 200 includes at least one processing circuit 210 configured to execute instructions, such as instructions for implementing the herein-described workloads, processes, or technology. Processing circuit 210 may include a microprocessor, a microcontroller, a graphics processor, a coprocessor, a field-programmable gate array, a programmable logic device, a signal processor, or any other circuit suitable for processing data. The aforementioned instructions, along with other data (e.g., datasets, metadata, operating system instructions, etc.), may be stored in operating memory 220 during run-time of computing device 200. Operating memory 220 may also include any of a variety of data storage devices/components, such as volatile memories, semi-volatile memories, random access memories, static memories, caches, buffers, or other media used to store run-time information. In one example, operating memory 220 does not retain information when computing device 200 is powered off. Rather, computing device 200 may be configured to transfer instructions from a non-volatile data storage component (e.g., data storage memory 250) to operating memory 220 as part of a booting or other loading process. In some examples, other forms of execution may be employed, such as execution directly from data storage memory 250, e.g., eXecute In Place (XIP).

Operating memory 220 may include 4^{th} generation double data rate (DDR4) memory, 3^{rd} generation double data rate (DDR3) memory, other dynamic random access memory (DRAM), High Bandwidth Memory (HBM), Hybrid Memory Cube memory, 3D-stacked memory, static random access memory (SRAM), magnetoresistive random access memory (MRAM), pseudorandom random access memory (PSRAM), or other memory, and such memory may comprise one or more memory circuits integrated onto a DIMM, SIMM, SODIMM, Known Good Die (KGD), or other packaging. Such operating memory modules or devices may be organized according to channels, ranks, and banks. For example, operating memory devices may be coupled to processing circuit 210 via memory controller 230 in channels. One example of computing device 200 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above-discussion, operating memory 220 specifically does not include or encompass communications media, any communications medium, or any signals per se.

Memory controller 230 is configured to interface processing circuit 210 to operating memory 220. For example, memory controller 230 may be configured to interface commands, addresses, and data between operating memory 220 and processing circuit 210. Memory controller 230 may also be configured to abstract or otherwise manage certain aspects of memory management from or for processing circuit 210. Although memory controller 230 is illustrated as single memory controller separate from processing circuit 210, in other examples, multiple memory controllers may be employed, memory controller(s) may be integrated with operating memory 220, or the like. Further, memory controller(s) may be integrated into processing circuit 210. These and other variations are possible.

In computing device 200, data storage memory 250, input interface 260, output interface 270, and network adapter 280 are interfaced to processing circuit 210 by bus 240. Although FIG. 2 illustrates bus 240 as a single passive bus, other configurations, such as a collection of buses, a collection of point-to-point links, an input/output controller, a bridge, other interface circuitry, or any collection thereof may also be suitably employed for interfacing data storage memory 250, input interface 260, output interface 270, or network adapter 280 to processing circuit 210.

In computing device 200, data storage memory 250 is employed for long-term non-volatile data storage. Data storage memory 250 may include any of a variety of non-volatile data storage devices/components, such as non-volatile memories, disks, disk drives, hard drives, solid-state drives, or any other media that can be used for the non-volatile storage of information. However, data storage memory 250 specifically does not include or encompass communications media, any communications medium, or any signals per se. In contrast to operating memory 220, data storage memory 250 is employed by computing device 200 for non-volatile long-term data storage, instead of for run-time data storage. Also, computing device 200 may include or be coupled to any type of processor-readable media such as processor-readable storage media (e.g., operating memory 220 and data storage memory 250) and communication media (e.g., communication signals and radio waves). While the term processor-readable storage media includes operating memory 220 and data storage memory 250, the term “processor-readable storage media,” throughout the specification and the claims whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like. The processor-readable storage media stores code or other computer-executable instructions which are executable by the processing circuit to configure the computing device to implement the disclosed methods and other functionality described herein.

Computing device 200 also includes input interface 260, which may be configured to enable computing device 200 to receive input from users or from other devices. In addition, computing device 200 includes output interface 270, which may be configured to provide output from computing device 200. In one example, output interface 270 includes a frame buffer, graphics processor, graphics processor or accelerator, and is configured to render displays for presentation on a separate visual display device (such as a monitor, projector, virtual computing client computer, etc.). In another example, output interface 270 includes a visual display device and is configured to render and present displays for viewing. In yet another example, input interface 260 and/or output interface 270 may include a universal asynchronous receiver/transmitter (UART), a Serial Peripheral Interface (SPI), Inter-Integrated Circuit (I2C), a General-purpose input/output (GPIO), and/or the like. Moreover, input interface 260 and/or output interface 270 may include or be interfaced to any number or type of peripherals.

In the illustrated example, computing device 200 is configured to communicate with other computing devices or entities via network adapter 280. Network adapter 280 may include a wired network adapter, e.g., an Ethernet adapter, a Token Ring adapter, or a Digital Subscriber Line (DSL) adapter. Network adapter 280 may also include a wireless network adapter, for example, a Wi-Fi adapter, a Bluetooth adapter, a ZigBee adapter, a Long-Term Evolution (LTE) adapter, SigFox, LoRa, Powerline, or a 5G adapter.

Although computing device 200 is illustrated with certain components configured in a particular arrangement, these components and arrangements are merely one example of a computing device in which the technology may be employed. In other examples, data storage memory 250, input interface 260, output interface 270, or network adapter 280 may be directly coupled to processing circuit 210, or be coupled to processing circuit 210 via an input/output controller, a bridge, or other interface circuitry. Other variations of the technology are possible.

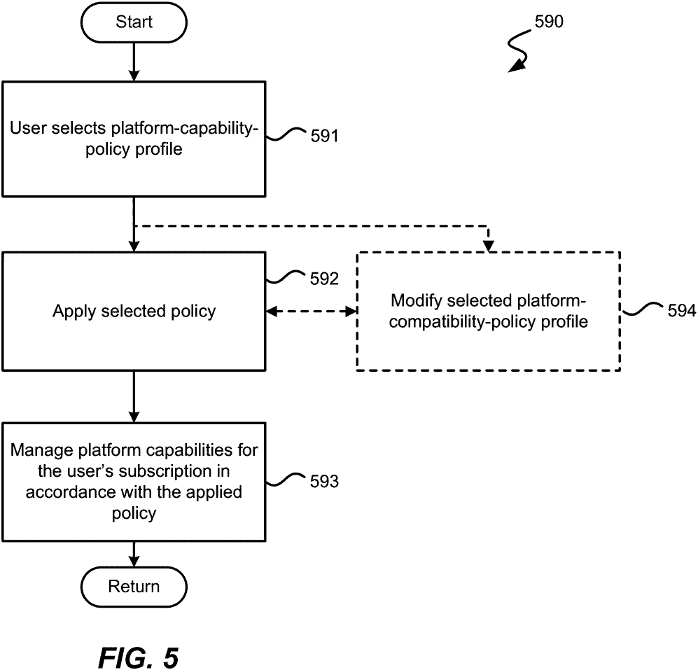

Some examples of computing device 200 include at least one memory (e.g., operating memory 220) having processor-executable code stored therein, and at least one processor (e.g., processing circuit 210) that is adapted to execute the processor-executable code, wherein the processor-executable code includes processor-executable instructions that, in response to execution, enables computing device 200 to perform actions, where the actions may include, in some examples, actions for one or more processes described herein, such as the process shown in FIG. 5, as discussed in greater detail below.

### Illustrative Systems

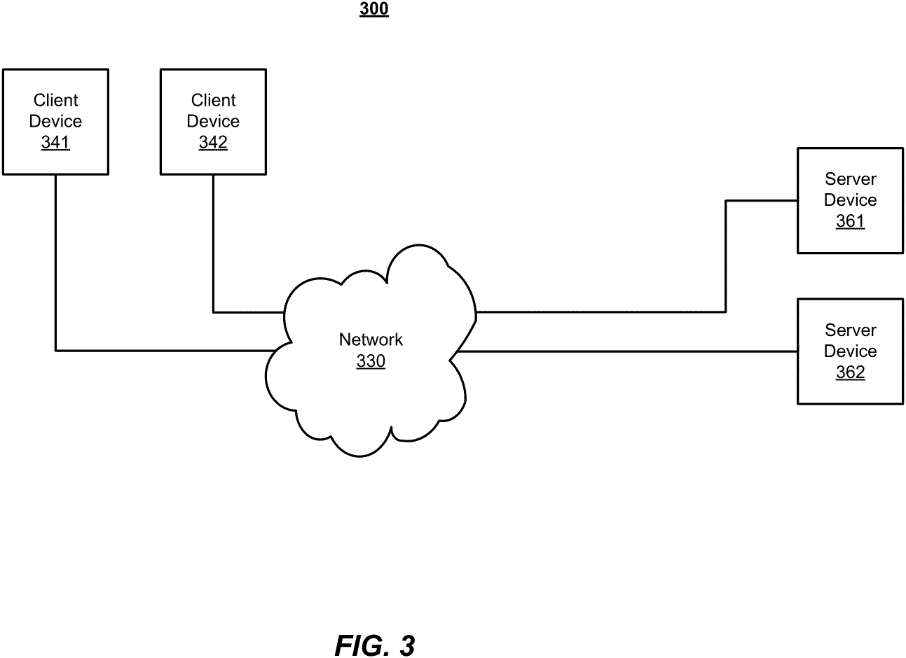

FIG. 3 is a block diagram illustrating an example of a system 300. System 300 may include network 330, as well as client devices 341 and 342; and server devices 361 and 362, which, in some examples, all connect to network 330.

Each of client devices 341 and 342 and server devices 361 and 362 may include examples of computing device 200 of FIG. 2. FIG. 3 and the corresponding description of FIG. 3 in the specification illustrate an example system for illustrative purposes that does not limit the scope of the disclosure. In some examples, server devices 361 and 362 are part of one or more distributed systems.

In some examples, server devices (including, e.g., server devices 361 and 362) manage a platform that is capable of providing one or more services to users. In some examples, the platform is a cloud platform provides cloud services to users. In some examples, the platform may create and manage virtual machines on behalf of users. In other examples, the platform may provide other suitable services to users. In some examples, client devices 341 and 342 may use services associated with the platform.

Network 330 may include one or more computer networks, including wired and/or wireless networks, where each network may be, for example, a wireless network, local area network (LAN), a wide-area network (WAN), and/or a global network such as the Internet. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 330 may include various other networks such as one or more networks using local network protocols such as 6LoWPAN, ZigBee, or the like. In essence, network 330 may include any suitable network-based communication method by which information may travel among client devices 341 and 342 and server devices 361 and 362. Although each device is shown connected as connected to network 330, that does not necessarily mean that each device communicates with each other device shown. In some examples, some devices shown only communicate with some other devices/services shown via one or more intermediary devices. Also, although network 330 is illustrated as one network, in some examples, network 330 may instead include multiple networks that may or may not be connected with each other, with some of the devices shown communicating with each other through one network of the multiple networks and other of the devices shown instead communicating with each other with a different network of the multiple networks.

System 300 may include more or less devices than illustrated in FIG. 3, which is shown by way of example only.

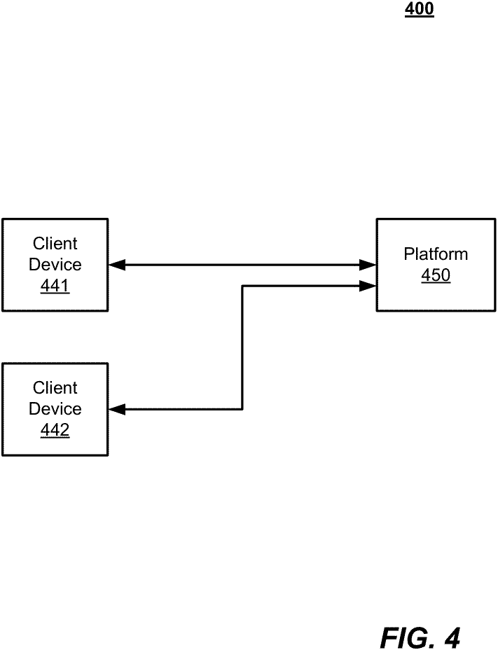

FIG. 4 is a block diagram illustrating an example of a system 400. System 400 may be an example of a portion of system 300 of FIG. 3. System 400 may be a system for platform-capability-policy profiles. System 400 may include client device 441, client device 442, and platform 450. Client devices 441 and 442 may be examples of client devices 341 and 342 of FIG. 2.

In some examples, platform 450 is a platform that is capable of providing one or more services to users. In some examples, platform 450 is a cloud platform that provides cloud services to users. In some examples, platform 450 may create and manage virtual machines on behalf of users. In other examples, platform 450 may provide other suitable services to users. In some examples, client devices 441 and 442 may use services associated with platform 450.

In some examples, platform 450 is a cloud platform that provides cloud services to user, including enabling the creation and management of virtual machines. In other examples, platform 450 may be another suitable type of platform that provides other suitable services to users.

In some examples, platform 450 may provide subscriptions, where subscriptions may be for single users or for organizations. Subscriptions may be management groups or the like, in some examples. The term “subscription” as used herein is not limited to a subscription as conventionally understood, but may include such a subscription as well as any suitable deployment or the like. In some examples, platform 450 enables an eligible user to select a profile for a user via a client device (e.g., client device 441 or 442) from among multiple available profiles that are presented for selection to the user(s). The multiple available profiles presented to the user(s) for selection may be a subset or a filtered set of profiles that are filtered from a larger set of available profiles, the filtering being based on characteristics associated with the user and/or the user device during the profile presentation and selection processes. For example, in some instances, different users will be presented different subsets of available profiles that correspond to different user preferences, locations, status, or other attributes and/or based on different configurations of the devices associated with the users. In some examples, the profiles among which the user may select each includes a set of two or more policies, where each of the policies governs platform capabilities of each of the users of the subscription. A user may also select different profiles for application to different devices associated with the user, such that each device will have a different profile applied to it. Each policy may be related to security, resilience, sovereignty, governance, dynamism, scale, or other suitable factors. The term “policy” as used herein may refer to a restraining policy or to one or more suitable tasks such as one or more scripts, one or more reports, or the like.

In some examples, a user can perform a profile selection and/or begin a subscription at any suitable time, including before creating an account or after creating an account. In some examples, the profile selection enables the user to select a desired experience when using the platform. In some examples, once the profile is selected and applied, only platform capabilities aligned with that experience are proactively made available to users of the subscription to which the profile has been applied. In some examples, the policy and the enforcement of the policy affect future experiences on the platform and what products are available to deploy on the platform for users of the subscription.

In some examples, a policy may deny users access to particular platform assets, such as for security reasons or other suitable reasons. In some examples, an asset denial may be accomplished by flagging and auditing. That is, in some examples, when a user attempts to access a particular platform asset, an indication may be provided to the user that access to the asset is not allowed (prior to granting access to the asset) according to a policy, and future reporting and auditing may indicate any prohibited platform assets that were accessed by users subsequent to and despite the warning/indication. In other examples, an asset denial may entirely deny access to an asset, so that the policy actually prevents users from accessing the assets that are denied according to the policy. Future reporting and auditing may also indicate assets that a user attempted to access, despite being denied access. In some examples, the use of enforcement preemptively ensures compliance with the policies by restricting the exact version of products and the exact products available via user interface (UI) and/or workflows.

Each of the profiles may include a set of two or more policies that are pre-configured to all work together, with validation performed to ensure that each of the policies in the profile work together properly. In some examples, the profile also governs the configuration over time, ensuring that, after the configuration, the policies all function properly, and ensuring the policies remain configured over time. In some examples, creation of each of the profiles includes elimination of any potential conflicts among the policies in the profile, and ensuring that none of the profiles contains incorrect settings that would otherwise not allow the set of profiles to work due to incompatibilities, incorrect configuration, and/or other issues.

In some embodiments, the profiles are modified over time, automatically and/or in response to user instructions. For instance, the system detects changes in software and/or hardware configurations associated with a policy, based on periodic auditing of the policy and software/hardware configurations and/or in response to input provided by the user or an administrator. When such a change is detected, the system will automatically or manually identify changes that can be made to the policy (e.g., updating definitions, restrictions, controls, versioning, or other updates) that ensure that the policies in the profile are correct and are compatible with the user device configurations. In some instances, the changes that warrant updating of a policy include changes in a user’s position or status within an organization, for example, or a change in a subscription level associated with a user and/or the association of a new device with the user that will be used to access server assets. When such changes occur, the user or administrator that manages the profiles may be prompted to select a new profile for the user and/or to manually change one or more of the policy settings. In some examples, the policies may govern types of devices available to users, for reasons of security, reasons of resilience, and/or or other suitable reasons. For instance, in some examples, a platform may include storage capabilities for users. In some examples, a user may not be sensitive to latency, but may need zonal resilience. (Zonal storage devices are a class of storage devices with an address space that is divided into zones which have write constraints different from regular storage devices.) In this case, the user may have selected a profile that only provides zonal storage, and does not provide local storage. In some examples, for users that have such a profile, local storage is never even presented to users of the subscription with this profile-instead, only zonal storage is ever presented or offered to the users of the subscription.

Types of devices or other types of platform assets available to users may be defined in different ways in different examples. In some examples, categories of devices available to users may be defined based on stock-keeping units (SKUs) of devices, virtual machines, and/or other products. For instance, in some examples, a platform may have zonal redundant storage devices that use one SKU and local redundant storage devices that use another SKU. Different SKUs may also be used to indicate different sizes of virtual machines. In some examples, a policy defines which SKUs are available to users, and which services are available to users. In other examples, categories of products may be defined in other suitable ways.

In some examples, a policy may define that only certain resources may be deployed in certain regions of platform 450. In some examples, a profile may have certain geography-based restrictions, for reasons of resilience, security, or other reasons. Likewise, in some examples, a policy may define that only certain resources may be deployed at only certain times and/or for only limited durations of time. In this regard, the profile may have certain time-based restrictions, for reasons of resilience, security, or other reasons. In some examples, each profile may mitigate a set of known risks based on the access to platform capabilities defined by the policy. In some examples, each profile has a descriptive name that indicates the intent of the profile, such as, in some examples, the known risks that the profile is capable of mitigating.

In some examples, a policy may provide security in various ways, such as by disallowing certain actions, or requiring certain things when particular actions are undertaken. For instance, when a user initiates a session for services and/or at any point during the session, the system/server may identify which profile is associated with a user and verify that the policies defined by the profile are applied for any service/asset requested by the user during the session. This process may include verifying configurations of the user device(s) and status of the user are consistent with and/or still compatible with recorded configurations/status information associated with the user and user profile that are recorded in a profile data structure that maps selected/assigned user profiles to user device and user status information.

In some examples, a policy may place restrictions and other rules to network access for security reasons. For instance, in some examples, a policy may disallow users from using any type of voice-over-internet protocol (VOIP) for security reasons. In some examples, a policy may provide network security in other ways, such as whether network traffic is exposed to the public network, by protecting all network from malicious traffic, or the like. For instance, in examples in which platform 450 instantiates virtual machines on behalf of users, the policy may govern which virtual machine network ports are accessible from the public internet. Also, in some examples, a policy may provide data protection in various ways, such as by controlling, if, how, and what data is encrypted, and by monitoring data for unauthorized data transfers in some examples.

In some examples, a policy may be used to provide resilience against low fidelity and corruption in latency. The policy may be configured with details about the latency between assets. Accordingly, in some examples, the policy can select a configuration that prevents users from being interrupted by latency-related mechanics, and the configuration is used as criteria for selecting assets. In some examples, resilience provided by a policy may also be related to a variety of other factors, including uptime.

In some examples, a policy provides each user with an experience with the profile selected for the subscription. For instance, in some examples, such an experience hides options that are not compatible with the policy. In some examples, input forms may be provided in a manner consistent with all policies of the subscription. For instance, in some examples, input forms may constrain options in the form (such as dropdowns) to exclude non-compliant options, and inputs (such as text boxes) may use in-context validation to inform the user of non-compliant inputs.

In some examples, one or more of the policies may include aspects of reporting, including overall levels of compliance with the policy, providing statistics related to resiliency achieved, and/or the like.

In some examples, policies may be used to govern identities, required authentications, and/or the like. For instance, in some examples, a policy could require multi-factor authentication (MFA) in order to perform administrative functions. In general, a policy may be used to define how and when authentication is done and required, and what type of authentication is required. The policy may also determine how to deal with medium- and high-risk identities. Identity risk may refer to the chance that a particular privileged identity is being used by someone other than the authorized user. The policy may identity that particular factors indicate a risk that the identity has been compromised. A policy may define certain actions to be performed when a high-risk identity is identified.

In some examples, enabling a user to select and apply a profile is accomplished in a relatively simple manner that makes it relatively easier for a user to select a particular profile according to that user’s specific needs. In some examples, a questionnaire may be used to assist the user in selecting a profile. As discussed above, in some examples, each profile has a descriptive name that indicates the intent of the profile, such as the known risks that the profile is capable of mitigating. In some examples, the profile selection process and the profile selection UI makes security, resilience, and other features accessible to non-experts, and may increase overall accessibility. The profile selection process and the profile selection UI may also enable visible accessibility to individuals who are visually challenged.

In some instances, as mentioned earlier, the profile selection process is further facilitated by prefiltering an initial set of profiles to only a filtered/subset of profiles that are determined (automatically) to match certain user attributes and/or user device configurations. For instance, the system may automatically identify different types of user attributes (e.g., organization domain, status within an organization, location, seniority, etc.), and which attributes are used to exclude or include profiles associated with such attributes for the filtered set of profiles. Similarly, user device configurations, such as hardware or software versions detected on the user device being used when the profile selection process is undertaken can be used to exclude or include certain profiles from the total set of available profiles into a filtered set of profiles that omits at least one or more of the total available profiles.

In some examples, the profiles may be templatized in such a way as to enable scalability of the application of policies to user subscriptions. In some examples, the manner in which policies that make up each profile are selected provides predictably to users in terms of the experience of each user in terms of platform capabilities available to the user, and in terms of the security and resilience provided to the user. Also, as discussed above, in some examples, the relative simplicity provided to users by the profiles, the profile selection process, and the profile selection UI may enable the benefits to profiles to be achieved by users who need not be experts, and may provide more security, better accessibility, and visual accessibility.

### Illustrative Processes

FIG. 5 a diagram illustrating an example dataflow for a process 590 for enabling platform-capability-policy profiles. In some examples, process 590 may be performed by one or more server devices 361 and/or 362 of FIG. 3, by platform 450 of FIG. 4, by one or more of computing device 200 of FIG. 2, or the like.

In the illustrated example, step 591 occurs first. At step 591, in some examples, a UI allows a user of a platform to select a platform-capability-policy profile. In some embodiments, allowing the user to select a platform-capability-policy profile includes providing a plurality of profiles for the user to select from among, and providing the user with, for each of the plurality of profiles, a descriptive name of the profile that characterizes a main intent for use and known risks that the profile is capable of mitigating.

It will be appreciated that the term ‘user’, as used herein, can apply to different types of entities, such as an individual end user (e.g., a particular person, such as an employee of an enterprise), as well as to a group of individual end user’s (e.g., an association of individuals, an enterprise, a company or other grouping of individuals that are collectively referred to as a client that includes one or more client devices (441, 442)). In this regard, the term user can also, therefore, collectively include both an administrator who selects the profile for another an end user, as well as the end user (e.g., employee) who accesses and uses the requested server/service assets according to the profile that is selected for them. In some instances, the user is both the administrator or other individual who selects the profile and who also accesses and uses the requested server/service assets according to the applied policies of the selected profile. In some instances, a first profile is selected/applied for a first set of one or more users of an enterprise/client system, who all have similar status within the client/enterprise, and in which a different set of one or more users of the enterprise/client system have a different profile applied/selected for them, based on differences in the status/attributes of the different users. The different status/attributes may be titles, seniority, assignment, locations and/or other attributes of the users. The differences between different sets of users may also be based on detected differences in the devices (actual device types and/or device configurations) associated with the different users.

In some embodiments, the selected platform-capability-policy profile includes a set of at least two platform-capability policies that are associated with at least one of security, resilience, sovereignty, governance, dynamism, or scale. In some embodiments, the platform-capability-policy profile includes two or more policies that are pre-configured and validated to work together. In some embodiments, the platform-capability-policy profile governs a type of device that is available to the user. In some embodiments, the platform-capability-policy profile places a restriction on network access.

As shown, step 592 occurs next in some examples. At step 592, in some examples, the one or more policy/policies of the selected platform-capability-policy profile is applied to a subscription that is associated with the platform of the user. This application of policy/policies may occur during an initiation of a session between a user and the server/service, so as to filter/restrict available services, resources and other assets that are made available to the user. The policy/policies may also be applied during an already established session, by checking permissions and authorizations for any requests that are received during a session.

As shown, step 593 occurs next in some examples. At step 593, in some examples, platform capabilities for subscribers of the subscription to which the profile was applied are managed according to the applied platform-capability-policy profile. The process may then advance to a return block, where other processing is resumed. Such additional processing may further include, for example, updating or modifying the platform-capability policy profile (step 594). This modification may be triggered by an automated determination that a change has occurred in a user status and/or device configuration. Likewise, the modification may be triggered in response to a user input requesting to review and modify one or more of the policies that are a part of the selected profile being applied to and managed for a particular user.

In some instances, the modification of a profile occurs prior to final application of a selected profile and its policy/policies to a user. For instance, when a user makes the initial selection of a policy, the user system can present a listing of all policies associated with that profile to the user. Then, the user can edit the profile by modifying the individual policies of the profile, by changing policy description, deleting a policy, adding a policy, updating a policy reference, and/or making other modifications to one or more of the policies in the profile. When a policy is changed, the profile can be updated and saved as an updated profile. Alternatively, the modified profile can be saved as a separate/new profile template (in addition to the pre-modified profile) for inclusion in the total available profiles presented to one or more users for new selection in subsequent profile selection processes.

The modification of a profile/profile policy may also occur at any point after the initial profile/policies of that profile are first selected for and applied to the user. For instance, if a user has an initial profile selected and applied (based on an initial subscription, device configuration and/or other user attribute setting), that profile can be switched and/or modified to be compatible with any dynamic changes in the user’s subscription, device configuration and other attributes that may change over time (e.g., new location, new software/hardware, new subscription, etc.). When a policy/profile is changed, the process of making the modification will also optionally include generating and sending an electronic notification to the user of the change in policy/policies for the modified profile.

In some embodiments, managing the platform capabilities of the subscription according to the applied platform-capability-policy profile further includes managing at least one configuration that is associated with the applied platform-capability-policy profile. This may include, for instance, updating an interface, application, file, driver or other software configuration installed on a user’s device.

In some embodiments, managing platform capabilities of the subscription according to the applied platform-capability-policy profile comprises at least one of providing an indication to the user that access to an asset is not allowed according to a policy, reporting that a prohibited platform asset was accessed by the user, or denying access to the asset.

### Conclusion

While the above Detailed Description describes certain examples of the technology, and describes the best mode contemplated, no matter how detailed the above appears in text, the technology can be practiced in many ways. Details may vary in implementation, while still being encompassed by the technology described herein. As noted above, particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

We claim:

1. An apparatus, comprising:
a device including at least one memory having processor-executable code stored therein, and at least one processor that is adapted to execute the processor-executable code, wherein the processor-executable code includes processor-executable instructions that, in response to execution, enable the device to perform actions, including:
via a user interface (UI), allowing a user of a platform to select a platform-capability-policy profile;
applying the selected platform-capability-policy profile to a subscription that is associated with the platform of the user; and
managing platform capabilities of the subscription according to the applied platform-capability-policy profile.

2. The apparatus of claim 1, wherein the selected platform-capability-policy profile includes a set of at least two platform-capability policies that are associated with at least one of security, resilience, sovereignty, governance, dynamism, or scale.

3. The apparatus of claim 1, wherein allowing the user to select a platform-capability-policy profile includes providing a plurality of profiles for the user to select from among, and providing the user with, for each of the plurality of profiles, a descriptive name of the profile that characterizes a main intent for use and known risks that the profile is capable of mitigating.

4. The apparatus of claim 1, wherein managing the platform capabilities of the subscription according to the applied platform-capability-policy profile further includes managing at least one configuration that is associated with the applied platform-capability-policy profile.

5. The apparatus of claim 1, wherein managing platform capabilities of the subscription according to the applied platform-capability-policy profile comprises at least one of:
providing an indication to the user that access to an asset is not allowed according to a policy;
reporting that a prohibited platform asset was either accessed by the user or attempted to be accessed by the user; or
denying access to the asset.

6. The apparatus of claim 1, wherein the platform-capability-policy profile includes two or more policies that are pre-configured and validated to work together.

7. The apparatus of claim 1, wherein the platform-capability-policy profile governs a type of device that is available to the user.

8. The apparatus of claim 1, wherein the platform-capability-policy profile places a restriction on network access.

9. A method, comprising:
via a user interface (UI), allowing a user of a platform to select a platform-capability-policy profile;
applying the selected platform-capability-policy profile to a subscription that is associated with the platform of the user; and
via at least one processor, managing platform capabilities of the subscription according to the applied platform-capability-policy profile.

10. The method of claim 9, wherein the selected platform-capability-policy profile includes a set of at least two platform-capability policies that are associated with at least one of security, resilience, sovereignty, governance, dynamism, or scale.

11. The method of claim 9, wherein allowing the user to select a platform-capability-policy profile includes providing a plurality of profiles for the user to select from among, and providing the user with, for each of the plurality of profiles, a descriptive name of the profile that characterizes a main intent for use and known risks that the profile is capable of mitigating.

12. The method of claim 9, wherein managing the platform capabilities of the subscription according to the applied platform-capability-policy profile further includes managing at least one configuration that is associated with the applied platform-capability-policy profile.

13. The method of claim 9, wherein managing platform capabilities of the subscription according to the applied platform-capability-policy profile comprises at least one of:
providing an indication to the user that access to an asset is not allowed according to a policy;
reporting that a prohibited platform asset was accessed by the user; or
denying access to the asset.

14. The method of claim 9, wherein the platform-capability-policy profile includes two or more policies that are pre-configured and validated to work together.

15. The method of claim 9, wherein the platform-capability-policy profile governs a type of device that is available to the user.

16. The method of claim 9, wherein the platform-capability-policy profile places a restriction on network access.

17. A processor-readable storage medium, having stored thereon processor-executable code that, upon execution by at least one processor, enables actions, comprising:
via a user interface (UI), allowing a user of a platform to select a platform-capability policy profile;
applying the selected platform-capability-policy profile to a subscription that is associated with the platform of the user; and
managing platform capabilities of the subscription according to the applied platform-capability-policy profile.

18. The processor-readable storage medium of claim 17, wherein the selected platform-capability-policy profile includes a set of at least two platform-capability policies that are associated with at least one of security, resilience, sovereignty, governance, dynamism, or scale.

19. The processor-readable storage medium of claim 17, wherein allowing the user to select a platform-capability-policy profile includes providing a plurality of profiles for the user to select from among, and providing the user with, for each of the plurality of profiles, a descriptive name of the profile that characterizes a main intent for use and known risks that the profile is capable of mitigating.

20. The processor-readable storage medium of claim 17, wherein managing the platform capabilities of the subscription according to the applied platform-capability-policy profile further includes managing at least one configuration that is associated with the applied platform-capability-policy profile.
